(19) United States
(12) Patent Application Publication
(10) Pub. No.: US 2026/0052073 A1
(43) Pub. Date: Feb. 19, 2026

(54) RRC PROCEDURE DESIGN FOR WIRELESS AI/ML

(71) Applicant: APPLE INC., Cupertino, CA (US)

(72) Inventors: Peng Cheng, Beijing (CN); Alexander Sirotkin, Hod Hasharon (IL); Fangli Xu, Beijing (CN); Zhibin Wu, Los Altos, CA (US); Huaning Niu, San Jose, CA (US); Haijing Hu, Los Gatos, CA (US); Ralf Rossbach, Munich (DE); Ping-Heng Kuo, London (GB); Yuqin Chen, Beijing (CN)

(21) Appl. No.: 19/103,607

(22) PCT Filed: Aug. 24, 2022
(86) PCT No.: PCT/CN2022/114569

§ 371 Date: Feb. 13, 2025

(51) Int. Cl. H04L 41/16; H04W 24/10

(52) U.S. Cl. CPC H04L 41/16; H04W 24/10

(57) ABSTRACT

There is provided an apparatus of a user equipment (UE), the apparatus comprising a processor, and a memory storing instructions that, when executed by the processor, configure the apparatus to receive an Artificial Intelligence (AI) model from a base station; obtain a trained AI model resulting from a training of the AI model; and send the trained AI model to the base station via an uplink Radio Resource Control (RRC) message.

### TECHNICAL FIELD

The present application relates generally to wireless communication systems, including providing Radio Resource Control (RRC) procedure design for wireless Artificial Intelligence (AI) or Machine learning (ML), for example, in a 5G communication system.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

In one aspect, there is provided an apparatus of a user equipment (UE), the apparatus comprising: a processor; and a memory storing instructions that, when executed by the processor, configure the apparatus to: receive an Artificial Intelligence (AI) model from a base station; obtain a trained AI model resulting from a training of the AI model; and send the trained AI model to the base station via an uplink Radio Resource Control (RRC) message.

In another aspect, there is provided an apparatus in a base station, the apparatus comprising: a processor; and a memory storing instructions that, when executed by the processor, configure the apparatus to: send an Artificial Intelligence (AI) model to a user equipment (UE); and receive, from the UE, a trained AI model resulting from a training of the AI model via an uplink Radio Resource Control (RRC) message.

In still another aspect, there is provided an apparatus of a user equipment (UE), the apparatus comprising: a processor; and a memory storing instructions that, when executed by the processor, configure the apparatus to: receive an Artificial Intelligence (AI) model trained by a base station via a downlink Radio Resource Control (RRC) message; and perform inference with the trained AI model.

In still another aspect, there is provided an apparatus in a base station, the apparatus comprising: a processor; and a memory storing instructions that, when executed by the processor, configure the apparatus to: train an Artificial Intelligence (AI) model; and configure the trained AI model to a User Equipment (UE) via an uplink Radio Resource Control (RRC) message.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to some embodiments of the present application.

FIG. 2 illustrates a system for performing signaling between a wireless device and a network device, according to some embodiments of the present application.

FIG. 3 illustrates an example flowchart for wireless AI/ML according to some embodiments of the present application.

FIG. 4 illustrates another example flowchart for wireless AI/ML according to some embodiments of the present application.

FIG. 5 illustrates another example flowchart for wireless AI/ML according to some embodiments of the present application.

FIG. 6 illustrates another example flowchart for wireless AI/ML according to some embodiments of the present application.

FIG. 7 an example flowchart for AI capability exchange procedure according to some embodiments of the present application.

FIG. 8 is a flowchart diagram illustrating an example method performed at the UE according to some embodiments of the present application.

FIG. 9 is a flowchart diagram illustrating an example method performed at the base station according to some embodiments of the present application.

FIG. 10 is a flowchart diagram illustrating an example method performed at the UE according to some embodiments of the present application.

FIG. 11 is a flowchart diagram illustrating an example method performed at the base station according to some embodiments of the present application.

### DETAILED DESCRIPTION

Various illustrative embodiments of the present application will be described hereinafter with reference to the drawings. For purpose of clarity and simplicity, not all features are described in the specification. Note that, however, many settings specific to the implementations can be made in practicing the embodiments of the present application. In addition, it should be noted that in order to avoid obscuring the description, some of the figures illustrate only steps of a process and/or components of a device that are closely related to the technical solutions of the present application, while in some other figures, well-known process steps and/or device structures are shown for only better understanding of the present application.

For convenient explanation, various aspects of the present application will be described below in the context of the 5G NR. However, it should be noted that this is not a limitation on the scope of application of the present application, and one or more aspects of the present application can also be applied to wireless communication systems that have been commonly used, such as the 4G LTE/LTE-A, or various wireless communication systems to be developed in future. Equivalents to the architecture, entities, functions, processes and the like as described in the following description may be found in these communication systems.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

Moreover, various embodiments are described with regard to a “base station”. However, reference to a base station is merely provided for illustrative purposes. The term “base station” as used in the present application is an example of a control device in a wireless communication system, with its full breadth of ordinary meaning. For example, in addition to the gNB specified in the 5G NR, the “base station” may also be, for example, a ng-eNB compatible with the NR communication system, an eNB in the LTE communication system, a remote radio head, a wireless access point, a relay node, a drone control tower, or any communication device or an element thereof for performing a similar control function.

### System Overview

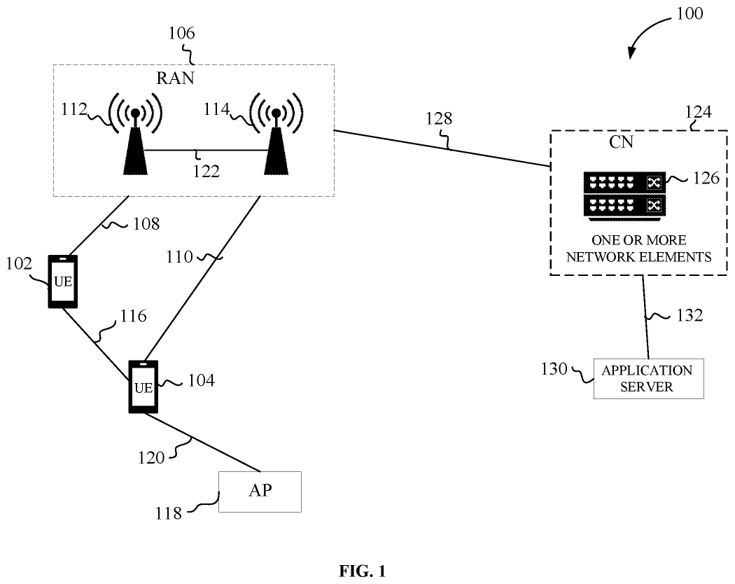

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to the 5GC, between a base station 112 (e.g., a gNB) connecting to 5GC and an eNB, and/or between two eNBs connecting to the 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

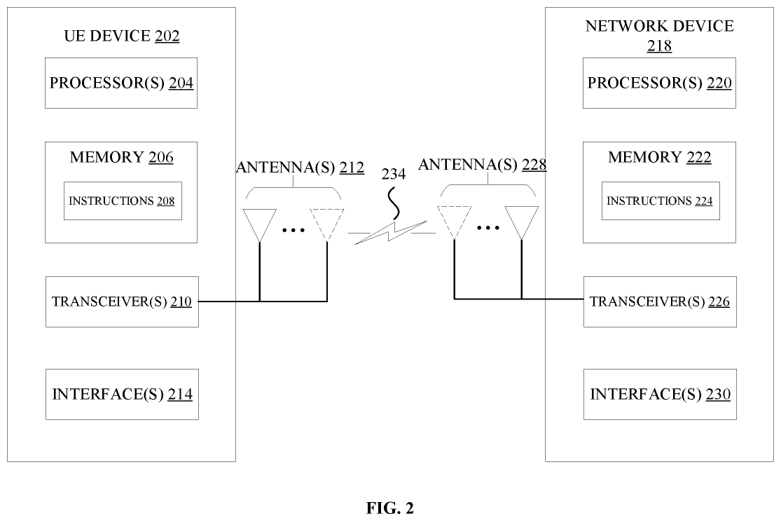

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Application of AI/ML to the wireless communication systems has gained tremendous interest in academic and industry research in recent years. AI provides a machine or system with ability to simulate human intelligence and behavior. ML may be referred to as a sub-domain of AI research. In some instances, the AI and ML terms may be used interchangeably. A typical implementation of AI/ML is neural network (NN), such as Conventional Neural Network (CNN), Recurrent/Recursive neural network (RNN), Generative Adversarial Network (GAN), or the like. The following description sometimes may take the neural network as example of AI/ML model, however, it is understood that the AI/ML model discussed here may be not limited thereto, and any other algorithm or model that performs inference on UE side or network side is possible.

Air interface design may be augmented with features enabling improved support of AI/ML based algorithms for enhanced performance and/or reduced complexity/overhead. Enhanced performance depends on use cases under consideration and could be, e.g., improved throughput, robustness, accuracy or reliability, etc. For example, the use cases may include:
channel state information (CSI) feedback enhancement, e.g., overhead reduction, improved accuracy, prediction or the like;
beam management, e.g., beam prediction in time, and/or spatial domain for overhead and latency reduction, beam selection accuracy improvement, or the like; and
positioning accuracy enhancements for different scenarios including, e.g., those with heavy Non-Line of Sight (NLOS) conditions.

Currently the use cases are explored in underlying physical (PHY) layer, for example, for improving processes in a modem (modulator-demodulator). However, there is a possibility to expand the use cases to processes in upper layers, such as medium access control (MAC) layer, radio resource control (RRC) layer, or the like.

It is expected that specific AI/ML models may be left to implementation by industrial vendors, such as UE vendors, network device vendors, network operators, or 3rd-party solution providers. With respect to a specific use case, there may be multiple vendors (e.g., the UE vendors, the network device vendors, or the like) developing different AI/ML algorithms and models. The storage and management of the AI/ML models may also be vendor specific and is possibly out of 3GPP scope. For example, a vendor may build its own AI/ML model library server to store and manage AI/ML models, while another vendor may rent from OTT.

However, it may be difficult or even impossible to coordinate two vendors on their AI/ML model library.

An AI/ML model may be implemented either as a one-sided model, which performs inference on one side (e.g., the UE side or the gNB side), or as a two-sided model, which performs inference on both of the UE side and the gNB side. The gNB and UE may not be willing to share their local data for training, for example, out of consideration for data privacy or business benefits. In this case, federated learning can be used to allow the AI/ML model to be trained locally without a transfer of data. In addition, compared with the gNB, the UE is restricted by its power consumption and complexity to run data training, and transfer learning can be used, that is, the AI/ML model is trained by the gNB and then is run by the UE.

Depending on where to train and use an AI/ML model, various levels of collaboration between the network and the UE may be defined. For example, the collaborations levels may be defined as no collaboration (Level x), signaling-based collaboration without model transfer (Level y), signaling-based coloration with model transfer (Level z), and the like.

However, there may occur a need that the UE aligns its understanding on AI/ML models with the gNB. For example, in a case where the training and/or inference of an AI/ML model takes place across the air interface between the UE and the gNB, the UE and the gNB have to be sync on the used AI/ML model.

Embodiments of the present application are provided to support RRC procedures for wireless AI/ML and are described below with reference to accompanying drawings.

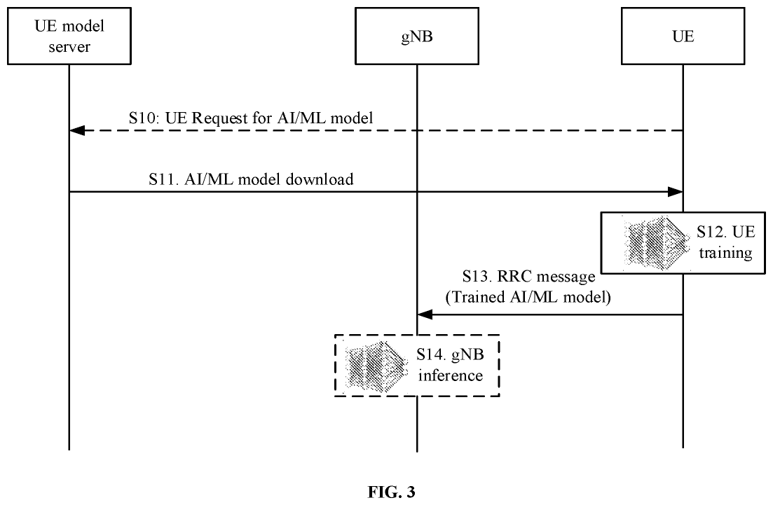

FIG. 3 illustrates an example flowchart for wireless AI/ML according to some embodiments of the present application. As shown in FIG. 3, in step S11, a UE may download an AI/ML model from its model server which is possibly built or rent by a UE vendor. Optionally, the downloading of the AI/ML may be initiated by a request from the UE (S10). Alternatively, the AI/ML may be pushed to the UE by the model server (not shown).

According to some embodiments of the present application, the downloaded AI/ML model may be included in a model file which contains a model structure of the AI/ML model and optionally initial model parameters. In a case where the AI/ML model is a deep neural network, the model file may include layers and initial weights/bias of the neural network. The model file may have a format depending on the machine learning framework that is used., such as a h5 format, a. ONNX format or the like. Optionally, the AI/ML may also include a unique model ID and metadata. The model ID is used for identifying the AI/ML model unambiguously, for example, within a Public Land Mobile Network (PLMN) or among several PLMNs, while the metadata is generated to describe various information regarding respective AI/ML model. Optionally, the AI/ML model data may be compressed for storage and/or transfer, for example, by using standard compression methods provided in ISO-IEC 15938-17 or any other possible compression methods, which will not be described here in detail.

The downloaded AI/ML model may be a one-sided model, and in this instance, the entire model is transferred from the model server to the UE. Alternatively, the AI/ML model may be a part of a two-sided model. In context of the present application, the AI/ML model may refer to either the one-side model or the two-sided model.

In an example, the downloading of the AI/ML model may employ conventional Over the Top (OTT) solution. The AI/ML model data is transmitted as application-layer data via User Plane (UP) of the operator network, which provides a tunnel transparent to the network (e.g., to the gNB). The UE receives and decapsulates protocol data units (PDUs) carrying the model data, and forwards the model data to its application layer.

In another example, the AI/ML model may be encapsulated in a transparent container, and the gNB may transfer the transparent container including the AI/ML model to the UE via a downlink RRC message, that is, via Control Plane. Segmentation may be supported for the RRC message to include the AI/ML model data with a high payload size. Access Stratum (AS) of the UE may receive the transparent container in the RRC message and forwards it to the application layer.

Then in step S12, the UE may train the AI/ML model with its local data by using various methods, such as a back propagation method. After performing the training, in step S13, the UE may send the trained model to the gNB via an uplink RRC message. For example, the trained AI/ML model may be transmitted as UE Assistance Information (UAI). For the transmission of the RRC message, Signalling Radio Bearer 4 (SRB4) may be configured by the network after AS security activation. Segmentation may be supported for the RRC message to include the trained AI/ML model data with a high payload size. Preferably, the trained AI/ML model may have its model ID (e.g., the same as the untrained AI/ML model) as well as relevant metadata.

In step S14, the gNB extracts the trained AI/ML model from the received RRC message. The trained AI/ML model may be used for various purposes. For example, the gNB may store the trained AI/ML model in a memory of its modem (modulator-demodulator), and configure the modem for inference of corresponding use case, such as the CSI feedback enhancement, the beam management, the positioning accuracy enhancement, or the like. For example, the gNB may train its part of the AI/ML model with reference to the trained part from the UE. For example, the gNB may perform a model fusion based on its training outcome and the UE's training outcome (e.g., the trained AI/ML model from the UE).

By means of the RRC procedure shown in FIG. 3, the UE and the gNB can align the understanding on the used AI/ML model.

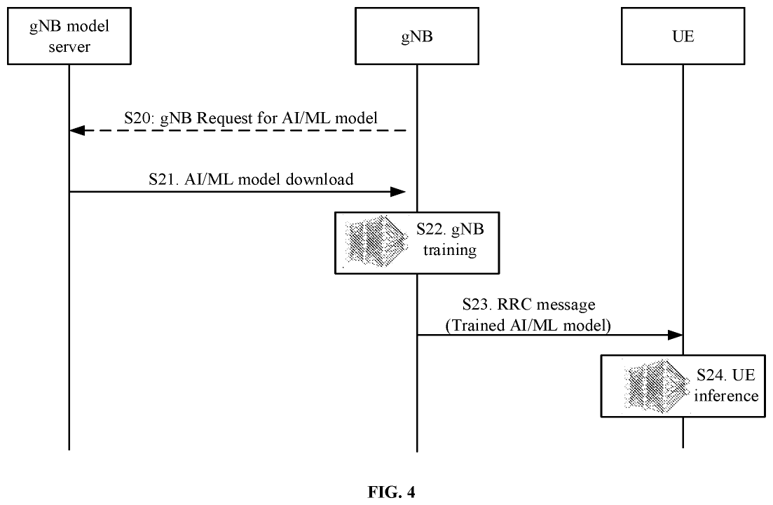

FIG. 4 illustrates another example flowchart for wireless AI/ML according to some embodiments of the present application. As shown in FIG. 4, in step S21, a gNB may download an AI/ML model from its model server which is possibly built or rent by a gNB vendor. The downloading of the AI/ML may be initiated by a request from the gNB (S20), or the AI/ML may be pushed to the gNB by the model server (not shown).

According to some embodiments of the present application, the downloaded AI/ML model may be included in a model file which contains a model structure of the AI/ML model and optionally initial model parameters. Optionally, the AI/ML may also include a unique model ID for identifying the AI/ML model and relevant metadata.

In an example, the downloading of the AI/ML model may employ the OTT solution, that is, the AI/ML model data is transmitted as application-layer data to the gNB via User Plane. In another example, the AI/ML model may be encapsulated in a container and transmitted to the gNB via Control Plane.

Then in step S22, the gNB may train the AI/ML model with its local data by using various methods. After performing the training, in step S23, the gNB may configure the trained model to the UE via a downlink RRC message. In the context of the present application, if the gNB “configures” the AI/ML model, the gNB is aware of the model. For example, the trained AI/ML model may be transmitted as RRC reconfiguration (Reconfig). For the transmission of the RRC message, SRB4 may be configured. Segmentation may be supported for the RRC message to include the trained AI/ML model data with a high payload size. Preferably, the trained AI/ML model may have its model ID (e.g., the same as the untrained AI/ML model) as well as relevant metadata.

In step S24, the UE extracts the trained AI/ML model from the received RRC message. The trained AI/ML model may be used for various purposes. For example, the UE may store the trained AI/ML model in a memory of its modem (modulator-demodulator), and configure the modem for inference of corresponding use case.

By means of the configuration of the AI/ML model shown in FIG. 4, the UE and the gNB can align the understanding on the used AI/ML model.

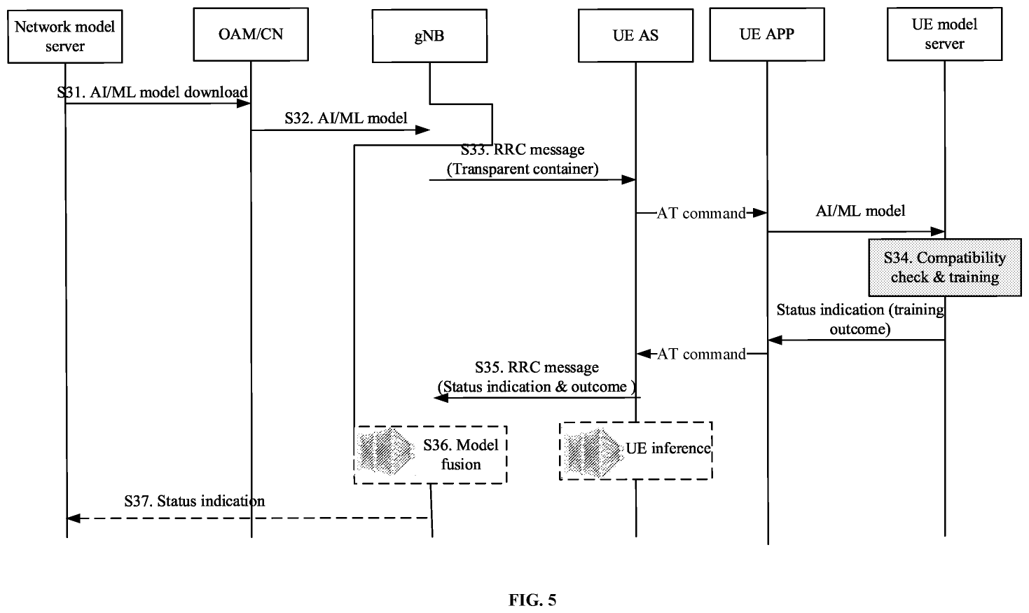

FIG. 5 illustrates another example flowchart for wireless AI/ML according to some embodiments of the present application. As shown by steps S31 and S32 in FIG. 5, the gNB may download an AI/ML model from AI/ML model library of a network server. The AI/ML model may include a model structure, and optionally initial parameters/weights and a model ID. The downloading of the AI/ML model may be through Operation Administration and Maintenance (OAM) or Core Network (CN) of the operator network, which may encapsulate the AI/ML model in a transparent container and send it to the gNB.

In step S33, the gNB sends the transparent container including the AI/ML model to the UE via a downlink RRC message. As stated above, RRC message segmentation may be supported to transfer the AI/ML model data with a high payload size. The Access Stratum (AS) of the UE receives the RRC message, and may forward the transparent container to the upper layer of the UE (such as a UE APP, a VAL client or another application layer client), for example, via an AT command which can provide a communication between the AS and the upper layer of the UE.

In step S34, the received AI/ML model may be subject to compatibility check. For example, the UE (e.g., the UE APP) may send the AI/ML model to a UE model server which is possibly operated by the UE vendor. The UE model server may verify the model's compatibility with the UE. When the AI/ML model is verified as being compatible with the UE, the UE model server may further train the model on UE-side data. As a result of the check and the training, a status indication may be generated. For example, the status indication may indicate any of “Success” which means the model is compatible with the UE and the training of the model is successful, “Failure” which means the model is compatible with the UE but the training of the model is failed, or “Model incompatible” which means the model is not compatible with the UE. However, it should be understood that the status indication may take other values.

The UE model server may feed the result of the compatibility check back to the UE (e.g., the UE APP). For example, in the case of successful training, the status indication “Success” and the training outcome of the AI/ML model (i.e., the trained AI/ML model) is sent to the UE, and in the case of failed training or incompatibility, the status indication “Failure” or “Model incompatible” is sent to the UE. The UE APP can forward the status indication and optionally the training outcome of the AI/ML model to the UE's AS via an AT command. In an instance, the UE may store the trained AI/ML model in a memory of its modem, and configure the modem for inference if the model is activated.

In step S35, the UE may send the status indication and the training outcome of the AI/ML model to the gNB via an uplink RRC message. If the status indication is “Success”, the gNB may perform inference with the trained model. Alternatively, as shown in step S36, the gNB may perform a model fusion based on a local training outcome of the AI/ML model and the received training outcome from the UE.

Optionally, the gNB may report the status indication to the network model server. For example, if the status indication is “Model incompatible” or “Failure”, the gNB may send an error report to the network model server.

By means of the compatibility check and the RRC procedure shown in FIG. 5, the gNB can align the understanding on the AI/ML model with the UE even if the model is sent to the UE transparently to the gNB.

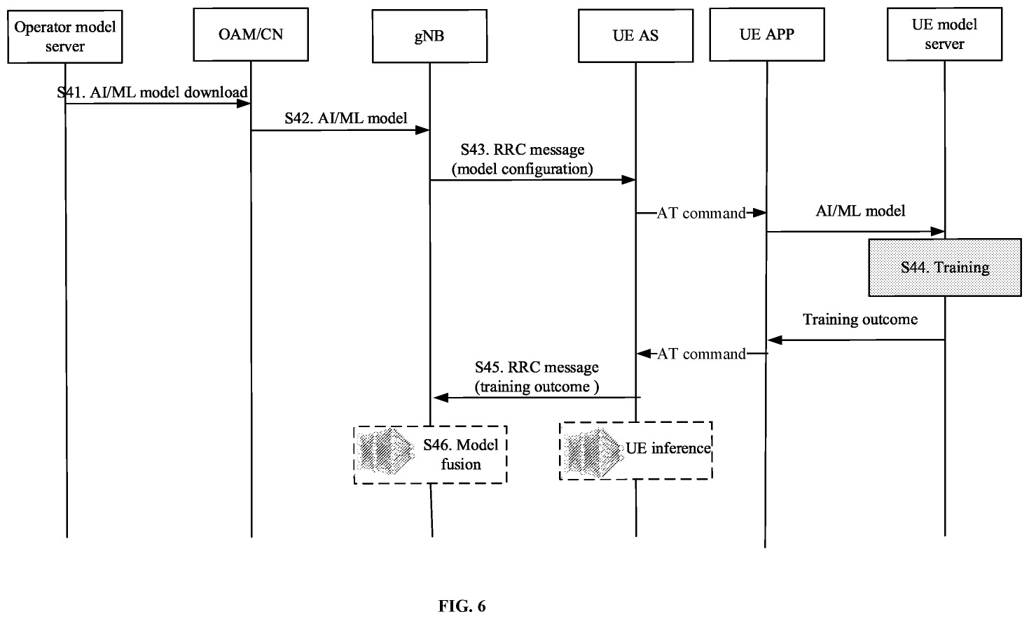

FIG. 6 illustrates another example flowchart for wireless AI/ML according to some embodiments of the present application. In the example of FIG. 6, the operator network manages the AI/ML library, so the UE and the gNB can download the same AI/ML model.

As shown in FIG. 6, the AI/ML model may be stored in an operator model server operated by the operator. In steps S41 and S42, the gNB may download an AI/ML model from AI/ML model library of the operator model server via an OAM or CN. The AI/ML model may include a model structure, and optionally initial parameters/weights and a model ID. Differently from FIG. 5, the downloading of the AI/ML model to the gNB is not transparent, so the gNB has access to the AI/ML model.

In step S43, the gNB configures the AI/ML model to the UE via a downlink RRC message. For example, the AI/ML model can be included as an Information Element (IE) in the RRC configuration. Also, RRC message segmentation may be supported to transfer the AI/ML model data with a high payload size. The AS of the UE receives the RRC message, and may extract and forward the AI/ML model to the application layer of the UE (such as a UE APP, a VAL client or another application layer client), for example, via an AT command.

In step S44, the received AI/ML model may be subject to an offline training. For example, the UE (e.g., the UE APP) may send the AI/ML model to a UE model server. After training the AI/ML model, the UE model server may send the training outcome to the UE (e.g., the UE APP). The UE APP can forward the training outcome of the AI/ML model to the UE's AS via an AT command. In an instance, the UE may store the trained AI/ML model in a memory of its modem, and configure the modem for inference if the model is activated.

In step S45, the UE may send the training outcome of the AI/ML model (i.e., the trained AI/ML model) to the gNB via an uplink RRC message, for example, as UE assistance information. The trained AI/ML model may be used for various purposes. For example, as shown in step S46, the gNB may perform a model fusion based on a local training outcome of the AI/ML model and the received training outcome from the UE.

By means of the RRC procedure shown in FIG. 6, the gNB can align the understanding on the AI/ML model with the UE.

According to some embodiments of the present application, the gNB may check AI capability and/or preference of the UE. FIG. 7 illustrates an example flowchart for AI capability exchange procedure which can be performed in the RRC layer.

As shown in FIG. 7, in step S51, the gNB may send an enquiry (UECapabilityEquiry) to the UE for its AI capability. As a response, in step S61, the UE may report its capability information (UECapabilityInformation) to the gNB. For example, the capability information may include a single bit to indicate whether the UE supports AI/ML (training or inference).

Alternatively, the capability information may include a group of bits to indicate coloration levels (e.g., Level x, y, z) the UE supports, supported use cases (e.g., the CSI feedback enhancement, the beam management, positioning accuracy enhancement), or the like.

The UE may also report its AI preference information (UEPreferenceInformation) to the gNB. The preference information may include one or more bits to indicate whether the UE is willing to run AI/ML, how long it can perform AI/ML, or the like. For example, the UE may be capable to perform AI/ML training or inference, but it is not wiling to because of battery status, and the preference information can indicate such information. The preference information may be reported as UE assistance information via a dedicated RRC message, or may be reported along with the capability information.

Based on the AI capability and/or preference information reported by the UE, the gNB may configure the UE via a RRC configuration message (e.g., RRC Reconfiguration). The RRC configuration message may indicate a collaboration level, or whether to stop or continue AI/ML at the UE.

The procedure in FIG. 7 may be employed in the flowcharts of FIGS. 3-6. For example, before step S11, S23, S33 or S43, the gNB may check the UE's capability and/or preference, and only when the UE is capable and/or willing to run the corresponding AI/ML model, the gNB send the model to the UE. For example, after checking the capability and preference of the UE, the gNB may indicate the collaboration level z in the downlink RRC message for sending the AI model, as shown in step S11, S23, S33 or S43.

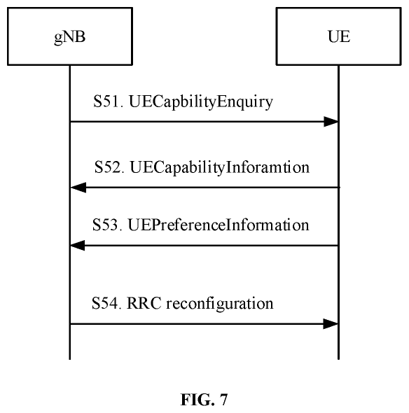

FIG. 8 is a flowchart diagram illustrating an example method for supporting the wireless AI/ML according to some embodiments of the present application. The method may be carried out at a UE.

At S101, the UE receives an AI model from a base station. The AI model may be sent via User Plane or Control Plane transparently to the base station, or may be configured by the base station in a non-transparent way.

At S102, the UE obtains a trained AI model by training the received AI model or by receiving training outcome from server.

At S103, the UE sends the trained AI model to the base station via an uplink RRC message.

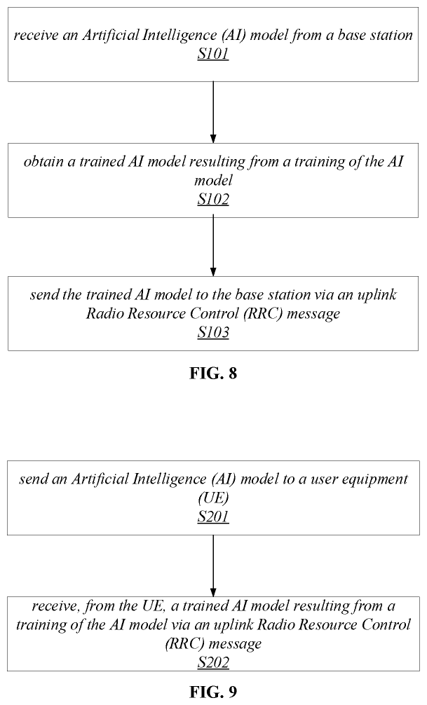

FIG. 9 is a flowchart diagram illustrating an example method for supporting the wireless AI/ML according to some embodiments of the present application. The method may be carried out at a base station, such as a gNB.

At S201, the base station sends an AI model to a UE. The AI model may be sent via User Plane or Control Plane transparently to the base station, or may be configured by the base station in a non-transparent way.

At S202, the base station receives, from the UE, a trained AI model via an uplink RRC message. The trained AI model may result from a training by the UE or by a UE model server.

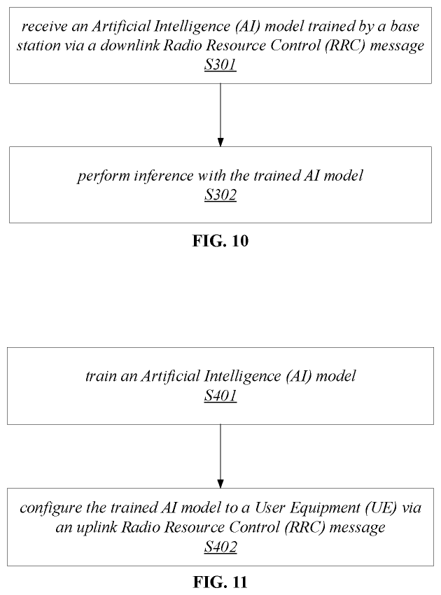

FIG. 10 is a flowchart diagram illustrating an example method for supporting the wireless AI/ML according to some embodiments of the present application. The method may be carried out at a UE.

At S301, the UE receives an AI model trained by a base station via a downlink RRC message. The AI model may be configured by the base station in a non-transparent way.

At S302, the UE may perform inference with the trained AI model.

FIG. 11 is a flowchart diagram illustrating an example method for supporting the wireless AI/ML according to some embodiments of the present application. The method may be carried out at a base station, such as a gNB.

At S401, the base station trains an AI model.

At S402, the base station configures the trained AI model to a UE via an uplink RRC message.

Embodiments contemplated herein include an apparatus comprising means to perform one or more elements of the method as shown in FIG. 8 or FIG. 10. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 8 or FIG. 10. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method as shown in FIG. 8 or FIG. 10. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 8 or FIG. 10. This apparatus may be, for example, an apparatus of a UE (such as a wireless device 202 that is a UE, as described herein).

Embodiments contemplated herein include a signal as described in or related to one or more elements of the method as shown in FIG. 8 or FIG. 10.

Embodiments contemplated herein include a computer program or computer program product comprising instructions, wherein execution of the program by a processor is to cause the processor to carry out one or more elements of the method as shown in FIG. 8 or FIG. 10. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method as shown in FIG. 9 or FIG. 11. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 9 or FIG. 11. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method as shown in FIG. 9 or FIG. 11. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 9 or FIG. 11. This apparatus may be, for example, an apparatus of a base station (such as a network device 218 that is a base station, as described herein).

Embodiments contemplated herein include a signal as described in or related to one or more elements of the method as shown in FIG. 9 or FIG. 11.

Embodiments contemplated herein include a computer program or computer program product comprising instructions, wherein execution of the program by a processing element is to cause the processing element to carry out one or more elements of the method as shown in FIG. 9 or FIG. 11. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

### Example section

The following examples pertain to further embodiments.

Example 1 may include an apparatus of a user equipment (UE), the apparatus comprising: a processor; and a memory storing instructions that, when executed by the processor, configure the apparatus to: receive an Artificial Intelligence (AI) model from a base station; obtain a trained AI model resulting from a training of the AI model; and send the trained AI model to the base station via an uplink Radio Resource Control (RRC) message.

Example 2 may include the apparatus of Example 1, wherein the AI model is received in a transparent container via a downlink RRC message.

Example 3 may include the apparatus of Example 1, wherein the AI model is received via User Plane.

Example 4 may include the apparatus of Example 1, wherein the AI model is received as a RRC configuration from the base station.

Example 5 may include the apparatus of Example 1, wherein the instructions that, when executed by the processor, further configure the apparatus to: obtain the trained AI model by training the AI model at the UE.

Example 6 may include the apparatus of Example 1, wherein the instructions that, when executed by the processor, further configure the apparatus to: transmit the AI model to a server; and obtain the trained AI model by receiving a training outcome of the AI model from the server.

Example 7 may include the apparatus of Example 6, wherein the instructions that, when executed by the processor, further configure the apparatus to: receive a status indication for the AI model from the server, wherein the status indication indicates at least one of a result of checking compatibility of the AI model with the UE, or a result of the training of the AI model.

Example 8 may include the apparatus of Example 1, wherein the instructions that, when executed by the processor, further configure the apparatus to: report, to the base station, one or more of capability information indicating AI capability of the UE, or preference information indicating AI preference of the UE.

Example 9 may include the apparatus of Example 8, wherein the preference information includes one or more of whether the UE prefers to use AI, or how long the UE prefers to use AI.

Example 10 may include the apparatus of Example 1, wherein the instructions that, when executed by the processor, further configure the apparatus to: receive, from the base station, a RRC configuration which is based on the capability information and/or the preference information.

Example 11 may include the apparatus of Example 10, wherein the RRC configuration includes one or more of a collaboration level between the UE and the base station, or when to stop using AI.

Example 12 may include an apparatus in a base station, the apparatus comprising: a processor; and a memory storing instructions that, when executed by the processor, configure the apparatus to: send an Artificial Intelligence (AI) model to a user equipment (UE); and receive, from the UE, a trained AI model resulting from a training of the AI model via an uplink Radio Resource Control (RRC) message.

Example 13 may include the apparatus of Example 12, wherein the AI model is sent in a transparent container of a RRC message.

Example 14 may include the apparatus of Example 12, wherein the AI model is sent as a RRC configuration.

Example 15 may include the apparatus of Example 12, wherein the AI model is sent via User Plane.

Example 16 may include the apparatus of Example 12, wherein the instructions that, when executed by the processor, further configure the apparatus to: perform inference with the trained AI model; or perform a model fusion based on training outcome of the AI model at the base station and the trained AI model from the UE.

Example 17 may include the apparatus of Example 12, wherein the instructions that, when executed by the processor, further configure the apparatus to: check AI capability and/or AI preference of the UE before sending the AI model to the UE.

Example 18 may include the apparatus of Example 12, wherein the instructions that, when executed by the processor, further configure the apparatus to: receive, from the UE, capability information indicating AI capability of the UE and/or preference information indicating AI preference of the UE; determine a RRC configuration based on the capability information and/or the preference information; and send the RRC configuration to the UE.

Example 19 may include the apparatus of Example 18, wherein the RRC configuration includes one or more of a collaboration level between the UE and the base station, or when to stop using AI.

Example 20 may include an apparatus of a user equipment (UE), the apparatus comprising: a processor; and a memory storing instructions that, when executed by the processor, configure the apparatus to: receive an Artificial Intelligence (AI) model trained by a base station via a downlink Radio Resource Control (RRC) message; and perform inference with the trained AI model.

Example 21 may include the apparatus of Example 20, wherein the RRC message supports a segmentation to include data of the AI model with high payload size.

Example 22 may include the apparatus of Example 20, wherein the trained AI model is identified by a model ID.

Example 23 may include the apparatus of Example 20, wherein the instructions that, when executed by the processor, further configure the apparatus to: report, to the base station, one or more of capability information indicating AI capability of the UE, or preference information indicating AI preference of the UE.

Example 24 may include the apparatus of Example 23, wherein the preference information includes one or more of whether the UE prefers to use AI, or how long the UE prefers to use AI.

Example 25 may include the apparatus of Example 23, wherein the instructions that, when executed by the processor, further configure the apparatus to: receive, from the base station, a RRC configuration which is based on the capability information and/or the preference information.

Example 26 may include the apparatus of Example 25, wherein the RRC configuration includes one or more of a collaboration level between the UE and the base station, or when to stop using AI.

Example 27 may include an apparatus in a base station, the apparatus comprising: a processor; and a memory storing instructions that, when executed by the processor, configure the apparatus to: train an Artificial Intelligence (AI) model; and configure the trained AI model to a User Equipment (UE) via an uplink Radio Resource Control (RRC) message.

Example 28 may include the apparatus of Example 27, wherein the RRC message supports a segmentation to include data of the trained AI model with high payload size.

Example 29 may include the apparatus of Example 27, wherein the instructions that, when executed by the processor, further configure the apparatus to: check AI capability and/or AI preference of the UE before sending the AI model to the UE.

Example 30 may include the apparatus of Example 29, wherein the instructions that, when executed by the processor, further configure the apparatus to: receive, from the UE, capability information indicating AI capability of the UE and/or preference information indicating AI preference of the UE; determine a RRC configuration based on the capability information and/or the preference information; and send the RRC configuration to the UE.

Example 31 may include the apparatus of Example 30, wherein the RRC configuration includes one or more of a collaboration level between the UE and the base station, or when to stop using AI.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE), the apparatus comprising:
a processor; and
a memory storing instructions that, when executed by the processor, configure the apparatus to:
receive an Artificial Intelligence (AI) model from a base station;
obtain a trained AI model resulting from a training of the AI model; and
send the trained AI model to the base station via an uplink Radio Resource Control (RRC) message.

2. The apparatus of claim 1, wherein the AI model is received in a transparent container via a downlink RRC message.

3. The apparatus of claim 1, wherein the AI model is received via User Plane.

4. The apparatus of claim 1, wherein the AI model is received as a RRC configuration from the base station.

5. The apparatus of claim 1, wherein the instructions that, when executed by the processor, further configure the apparatus to:
obtain the trained AI model by training the AI model at the UE.

6. The apparatus of claim 1, wherein the instructions that, when executed by the processor, further configure the apparatus to:
transmit the AI model to a server; and
obtain the trained AI model by receiving a training outcome of the AI model from the server.

7. The apparatus of claim 6, wherein the instructions that, when executed by the processor, further configure the apparatus to:
receive a status indication for the AI model from the server, wherein the status indication indicates at least one of a result of checking compatibility of the AI model with the UE, or a result of the training of the AI model.

8. The apparatus of claim 1, wherein the instructions that, when executed by the processor, further configure the apparatus to:
report, to the base station, one or more of capability information indicating AI capability of the UE, or preference information indicating AI preference of the UE.

9. The apparatus of claim 8, wherein the preference information includes one or more of whether the UE prefers to use AI, or how long the UE prefers to use AI.

10. The apparatus of claim 8, wherein the instructions that, when executed by the processor, further configure the apparatus to:
receive, from the base station, a RRC configuration which is based on the capability information and/or the preference information.

11. The apparatus of claim 10, wherein the RRC configuration includes one or more of a collaboration level between the UE and the base station, or when to stop using AI.

12. An apparatus in a base station, the apparatus comprising:
a processor; and
a memory storing instructions that, when executed by the processor, configure the apparatus to:
send an Artificial Intelligence (AI) model to a user equipment (UE); and
receive, from the UE, a trained AI model resulting from a training of the AI model via an uplink Radio Resource Control (RRC) message.

13. The apparatus of claim 12, wherein the AI model is sent in a transparent container of a RRC message.

14. The apparatus of claim 12, wherein the AI model is sent as a RRC configuration.

15. The apparatus of claim 12, wherein the AI model is sent via User Plane.

16. The apparatus of claim 12, wherein the instructions that, when executed by the processor, further configure the apparatus to:
perform inference with the trained AI model; or
perform a model fusion based on training outcome of the AI model at the base station and the trained AI model from the UE.

17. The apparatus of claim 12, wherein the instructions that, when executed by the processor, further configure the apparatus to:
check AI capability and/or AI preference of the UE before sending the AI model to the UE.

18. The apparatus of claim 17, wherein the instructions that, when executed by the processor, further configure the apparatus to:
receive, from the UE, capability information indicating AI capability of the UE and/or preference information indicating AI preference of the UE;
determine a RRC configuration based on the capability information and/or the preference information; and
send the RRC configuration to the UE.

19. The apparatus of claim 18, wherein the RRC configuration includes one or more of a collaboration level between the UE and the base station, or when to stop using AI.

20. An apparatus of a user equipment (UE), the apparatus comprising:
a processor; and
a memory storing instructions that, when executed by the processor, configure the apparatus to:
receive an Artificial Intelligence (AI) model trained by a base station via a downlink Radio Resource Control (RRC) message; and
perform inference with the trained AI model.

21-31. (canceled)
